(19) United States
(12) Patent Application Publication
(10) Pub. No.: US 2026/0141667 A1
(43) Pub. Date: May 21, 2026

(54) METHOD AND DEVICE FOR FULL-BODY SEGMENTATION MAPPING IN AN IMAGE BASED ON JOINT COLOR COMPONENT AND ATTRIBUTE CLASSIFICATION

(71) Applicant: Samsung Electronics Co., Ltd., Gyeonggi-do (KR)

(72) Inventors: Mostafa EL-KHAMY, San Diego, CA (US); Ahmad SADEED, Escondido, CA (US)

(21) Appl. No.: 19/189,819

(22) Filed: Apr. 25, 2025

Related U.S. Application Data
(60) Provisional application No. 63/722,226, filed on Nov. 19, 2024.

(51) Int. Cl. G06V 10/26; G06V 10/762; G06V 10/764; G06V 10/82; G06V 40/16

(52) U.S. Cl. CPC G06V 10/26; G06V 10/762; G06V 10/764; G06V 10/82; G06V 40/161; G06V 40/172

(57) ABSTRACT

A method and device are provided in which the device identifies a person instance in an image, and generates an attribute classification and a color component classification for a facial region of the person instance. The device also combines the attribute classification and the color component classification into a single classification for the facial region, propagates the single classification to remaining natural portions of the person instance in the image.

### CROSS-REFERENCE TO RELATED APPLICATION

This application claims the priority benefit under 35 U.S.C. § 119(e) of U.S. Provisional Application No. 63/722,226, filed on Nov. 19, 2024, the disclosure of which is incorporated by reference in its entirety as if fully set forth herein.

### TECHNICAL FIELD

The disclosure generally relates to pixel prediction for image enhancement. More particularly, the subject matter disclosed herein relates to improvements to full-body segmentation mapping in an image based on color component and attribute classification.

### SUMMARY

Semantic segmentation is a foundational task in computer vision that assigns a class label to every pixel in an image, creating a segmentation map to identify objects or regions of interest. This technology is critical for applications such as autonomous driving, medical imaging, augmented reality, and image restoration. Recent advancements in deep learning, including neural networks (NNs), have led to significant progress in semantic segmentation. However, generating highly accurate and consistent segmentation maps remains a complex challenge, particularly in scenarios requiring full-body segmentation

In the context of dense pixel prediction, semantic segmentation enables detailed classifications that support tasks like image super-resolution, denoising, and enhancement. These tasks rely on segmentation maps to guide region-specific enhancements such as sharpening, smoothing, or adjusting brightness. For example, segmentation maps can isolate facial features, clothing, or skin regions, enabling targeted enhancements based on context. Despite these advancements, full-body segmentation, especially for detailed classifications such as color component and attribute, presents significant technical hurdles.

Conventional methods for segmentation are often limited to face detection, where analysis is restricted to specific regions such as facial skin. These approaches do not address the challenges of full-body segmentation, leaving substantial gaps in generating segmentation maps that encompass the entire human form. When manual annotation is used to create segmentation maps, the process becomes labor-intensive, time-consuming, and costly. Pixel-level manual annotations are also prone to inconsistencies, as human annotators may produce variable results for the same regions due to differences in judgment, lighting, and occlusions.

Automated systems, while offering faster alternatives to manual annotation, frequently struggle with accuracy and consistency. Variations in pose, occlusions, diverse lighting conditions, and image resolutions contribute to misclassifications and fragmented segmentation. Additionally, existing datasets and algorithms may lack sufficient diversity, leading to biased or incomplete representations of color components, attributes, or body types. This can result in inaccurate segmentation, particularly in scenarios involving individuals with overlapping or occluded body parts.

Another significant challenge arises from the need for pixel-level consistency. Traditional segmentation methods often result in mismatched classifications, where pixels belonging to the same person or region are incorrectly assigned to different categories. For example, different pixels of the same individual's skin may be classified under varying color component or attribute categories, leading to unreliable results.

To overcome these issues, systems and methods are described herein for a novel pipeline for generating a ground truth color component-attribute segmentations for a whole body using semantic and instance segmentations of body parts. NN-based and clustering-based classification models are applied to assign color component categories to detected faces, which are confidence-filtered and combined with attribute classifications into a combined classification. Additionally, the invention supports both automated and manual annotation workflows.

The above approach improves on previous methods by providing an end-to-end pipeline for accurate full-body segmentation. By leveraging facial classification as the foundation for labeling, the invention ensures consistency across all body pixels for a given person. The combined use of instance and semantic segmentation models eliminates errors related to unnatural regions, such as clothing, while reducing computational cost and manual effort.

In an embodiment, a method is provided in which a processor of an electronic device identifies a person instance in an image, and generates an attribute classification and a color component classification for a facial region of the person instance. The processor also combines the attribute classification and the color component classification into a single classification for the facial region, and propagates the single classification to remaining natural portions of the person instance in the image.

In an embodiment, a method is provided in which a processor of an electronic device detects a facial region of a person instance in an image using a face detection model. The processor determines, via a first neural network, an attribute classification based on the facial region, determines, via a second neural network, a first color component classification for the facial region, and determines, via a clustering-based algorithm, a second color component classification for the facial region based on dominant colors of clustered pixels. The processor also determines a color component classification for the facial region from among the first color component classification and the second color component classification, and combines the attribute classification and the color component classification into a single classification for the facial region.

In an embodiment, an electronic device is provided that includes a processor and a non-transitory computer readable storage medium storing instructions. When executed, the instructions cause the processor to identify a person instance in an image, generate an attribute classification and a color component classification for a facial region of the person instance, combine the attribute classification and the color component classification into a single classification for the facial region, and propagate the single classification to remaining natural portions of the person instance in the image.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating an electronic device, according to an embodiment;

FIG. 2 is a diagram illustrating a pipeline for generating a color component/attribute classification to be used in segmentation maps, according to an embodiment;

FIG. 3 is a diagram illustrating a pipeline for generating color component/attribute classifications, according to an embodiment;

FIG. 4 is a diagram illustrating propagation of color component/attribute classification to all natural body parts, according to an embodiment;

FIG. 5 is a diagram illustrating propagation of color component/attribute classification to natural body parts using human annotation, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An electronic device, according to one embodiment, may be one of various types of electronic devices utilizing storage devices (e.g., memory devices). The electronic device may use any suitable storage standard, such as, for example, peripheral component interconnect express (PCIe), nonvolatile memory express (NVMe), NVMe-over-fabric (NVMeoF), advanced extensible interface (AXI), ultra path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), and/or the like, or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), and/or the like, or any combination thereof. Any of the memory devices may be implemented with one or more of any type of memory device interface including double data rate (DDR), DDR2, DDR3, DDR4, DDR5, low-power DDR (LPDDRX), open memory interface (OMI), Nvlink high bandwidth memory (HBM), HBM2, HBM3, and/or the like. The electronic devices may include, for example, a portable communication device (e.g., a smart phone), a computer, a portable multimedia device, a portable medical device, a camera, a wearable device, or a home appliance. However, an electronic device is not limited to those described above.

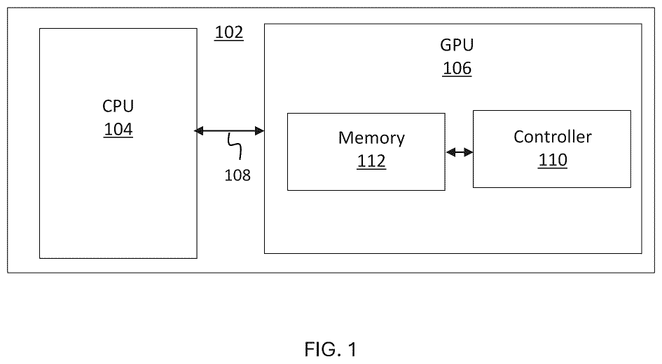

FIG. 1 is a diagram illustrating an electronic device, according to an embodiment. An electronic device (or user equipment (UE)) 102 may include multiple processing components that require efficient memory for management. The electronic device 102 may include a central processing unit (CPU) 104 and an accelerator, such as a graphics processing unit (GPU) 106, interconnected by a memory bus 108. These processing units rely on memory subsystems that must balance high-speed data access with low power consumption. For example, the GPU 106 may include a controller 110 (e.g., computational engines and processors) and a memory 112.

According to an embodiment, a method is provided for generating segmentation maps for predefined color component/attribute classifications given an image. While embodiments described herein apply segmentation map generation to people within an image, the same methods may be applied to any object in the image. A color component/attribute classification may consider a person's attribute (e.g., race, texture, opacity) and color component (e.g., skin-tone, hue, brightness). This method results in a segmentation map, where for each person in an image, all their natural body parts are labeled for color component/attribute classifications. The ground truth segmentation maps along with the original images may be used to train deep NNs for semantic segmentation, panoptic segmentation, and instance segmentation, and for image and video restoration algorithms, such as super resolution and denoising.

In addition to employing human annotators to generate ground truth labels for different color component/attribute types on new data, a pipeline for automatic generation of color component/attribute classifications for existing data may be employed.

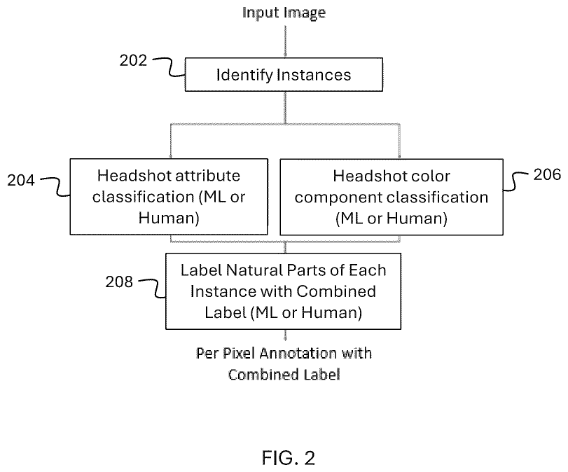

FIG. 2 is a diagram illustrating a pipeline for generating a color component/attribute classification to be used in segmentation maps, according to an embodiment. Specifically, a method is provided for generating segmentations for people in an image, or an image sequence, where the classifications in the segmentation maps indicate each person's attribute and color component. At 202, person instances in an image may be identified. At 204, an attribute classification operation may be performed on facial regions of the person instances through machine learning or human annotation. At 206, a color component classification operation may be performed on the facial regions of the person instances through machine learning or human annotation. At 208, natural parts of each person instance may be labeled with a combined color component/attribute classification through machine learning or human annotation, resulting in per pixel annotation with the combined classification. The generated segmentation maps may cover all natural body parts.

The segmentation maps may serve as an input for downstream image enhancement tasks such as super-resolution, denoising, and overall image enhancement. By leveraging the combined classifications, these enhancement modules may apply region-specific filters tailored to the unique visual characteristics of each identified area. For example, facial regions or areas may be selectively sharpened to enhance fine details, while adjacent regions could be smoothed or brightness-adjusted to ensure consistent image quality.

The integration of segmentations maps into image processing pipelines allows for adaptive filter selection based on the classification of each region. Enhancement algorithms may dynamically choose from filters or color correction profiles that are typically preferred for specific combined classifications. In super-resolution tasks, the segmentation maps may guide the upscaling process, ensuring that the fine structural details of key areas (e.g., eyes, lips, or hair) are preserved and enhanced without introducing noise into the background or less detailed regions.

The segmentation maps may facilitate a more robust noise reduction strategy in denoising applications. By distinguishing between different regions of an image, the model can apply varying degrees of denoising strength. For example, higher noise suppression may be applied in background regions, while edge and texture details may be preserved in foreground human features. This adaptive approach ensures that the final enhanced image maintains both visual clarity and authenticity.

The use of segmentations maps based on the combined classification may bolster performance of image enhancement algorithms and may enable a level of customization that aligns with the nuanced requirements of modern imaging applications.

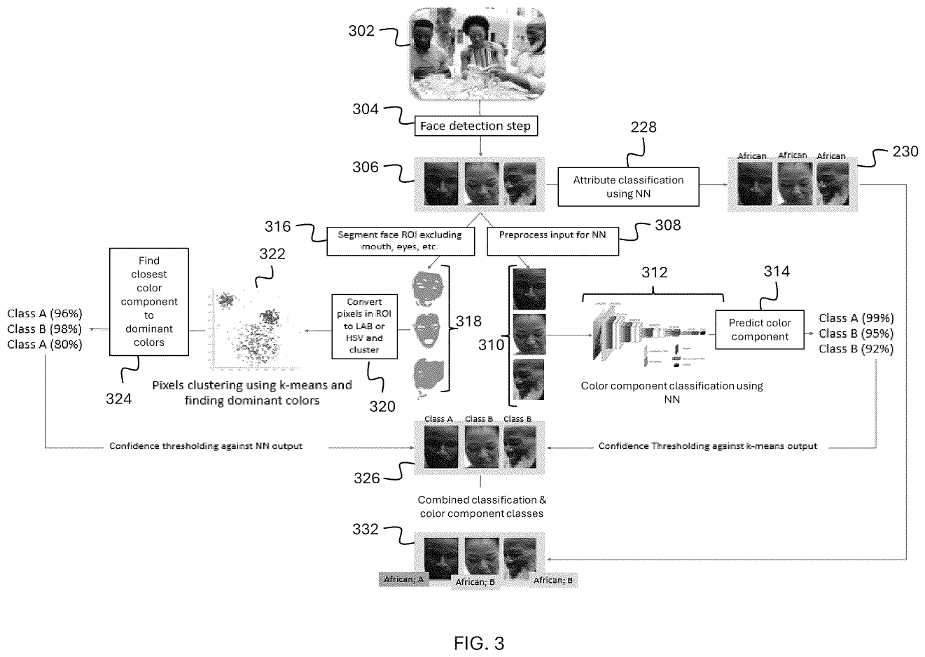

FIG. 3 is a diagram illustrating a pipeline for generating color component/attribute classifications, according to an embodiment. Facial regions in an image 302 may be detected using any state-of-the-art facial detection model 304 to isolate individual faces from the respective bodies in the image. Facial regions 306 may then be passed to a convolutional neural network (CNN)-based classification model and a clustering-based classification model to generate color component classifications. For the CNN-based image classification model, the facial regions 306 may be preprocessed for the CNN at 308, and a color component classification operation may be performed on preprocessed facial regions 310, at 312, resulting in predicted color component classifications for each face 314. For example, a first facial region may be predicted as class A with 99% confidence, a second facial region may be predicted as class B with 95% confidence, and a third facial region may be predicted as class B with 92% confidence. The CNN-based image classification model may include models such as, for example, visual geometry group (VGG)-19, VGG-Face, residual network (ResNet), or InceptionResNet. Any of the described models may be trained on a large dataset of faces classified for color component.

For clustering-based classification, at 316, a face segmentation model may be used to identify the pixels belonging to facial regions of interest (ROI) 318, which include skin-covered areas, but exclude areas such as eyes, teeth, hair and lips. At 320, pixels in the ROIs may be converted into a hue, saturation, value (HSV) color space or a lightness, a, b (LAB) color space. At 322, a clustering-based algorithm, such as k-means, may be used to cluster the pixels from the ROIs into dominant colors. At 324, a color component classification may be determined based on the dominant colors. To find a color component classification for the facial region, a distance d∈[0,1] of each of the predefined color component colors from the average of the dominant colors may be determined. The closest color (using real value d) may be the label for the facial region. The confidence score for the color component classification may be 100*(1−d). Specifically, if the distance of a classification from the dominant color average is 0, the confidence is 100%. Accordingly, a first facial region may be predicted as class A with 96% confidence, a second facial region may be predicted as class B with 98% confidence, and a third facial region may be predicted as class C with 80% confidence. Generation of the color component labels may also be performed using different models (e.g., two CNNs), different thresholding criteria, or a single high performing model.

Using the outputs of the two classification models, a color component classification may be assigned to each facial region after confidence thresholding, at 326. For example, using the two predictions for a given facial region, a color component classification having a higher confidence score may be chosen.

In order to generate attribute classifications for each facial region, the facial regions 306 may also be passed to a CNN-based attribute classification model 328 to generate attribute-classified facial regions 330 from a predefined list of attributes. At 332, a combined color component and attribute classification may be assigned for each face as a combination of color component S and attribute R.

To generate ground truth segmentation, an instance segmentation model may be employed for person class to propagate the color component/attribute classification to the whole natural body. Unnatural parts such as clothes may be excluded from the segmentations using a semantic segmentation model. Similarly, a human annotator can accomplish the tasks by labeling each face for color component/attribute, perform instance segmentation of person class and perform semantic segmentation for person related classes. An automatic tool may be used to generate color component/attribute segmentation using the outputs of human annotations from previous step.

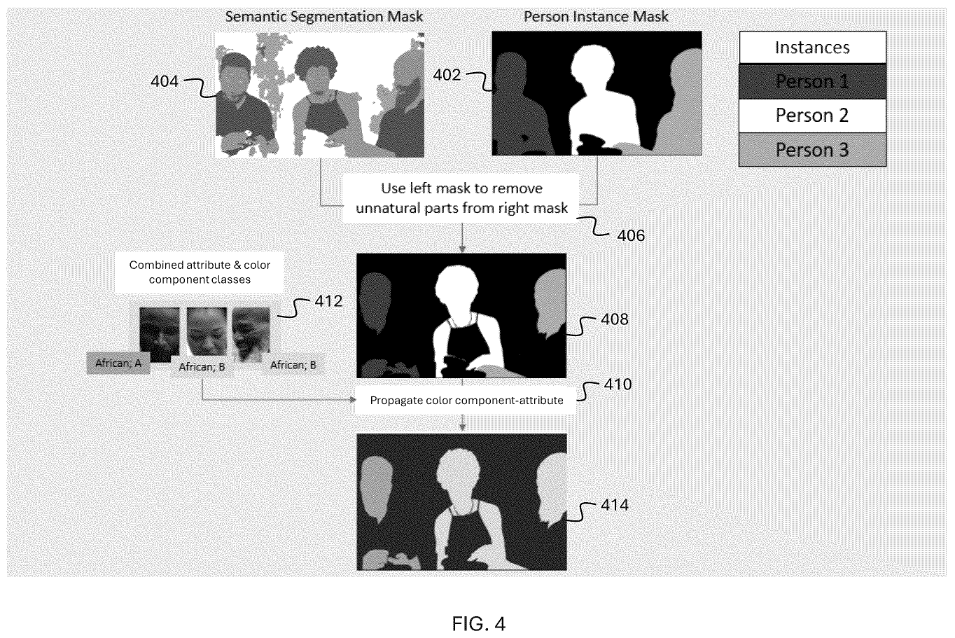

FIG. 4 is a diagram illustrating propagation of color component/attribute classification to all natural body parts, according to an embodiment. The color component/attribute classifications have been generated and segmentations need to be generated where each person in the image is labeled based on their color component/attribute classification. To generate the segmentation, an instance segmentation model for person class may be employed to segment each person in a person instance mask 402. An existing semantic segmentation model may be employed to segment different areas on the human body in a segmentation mask 404. At 406, the segmentation mask 404 may be used to remove unnatural parts from the person instance mask 402, resulting in mask 408. At 410, the combined color component/attribute classification 412, generated from FIG. 3, may be propagated to entire natural bodies of the individual in the mask 408, resulting in a skin-ton/attribute segmentation mask 414.

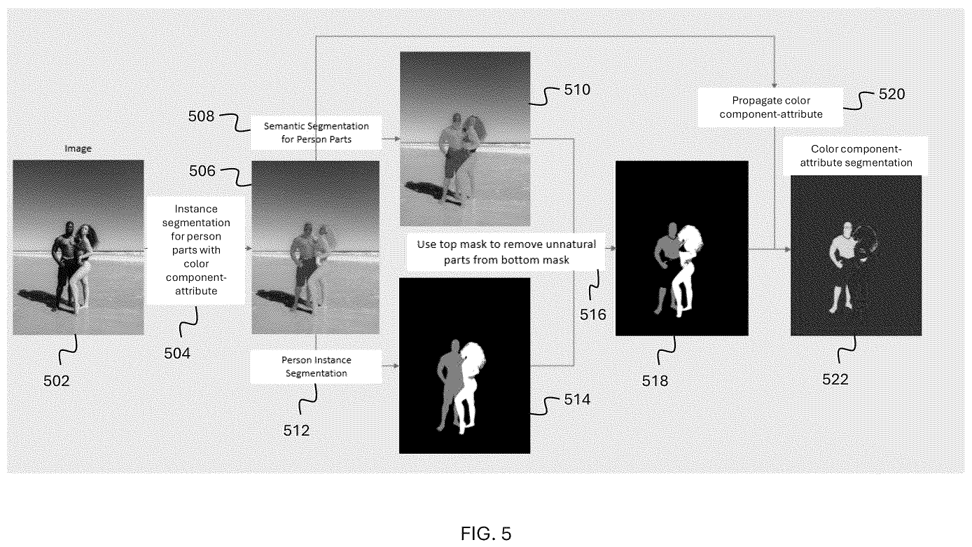

FIG. 5 is a diagram illustrating propagation of color component/attribute classification to natural body parts using human annotation, according to an embodiment. Using an original image 502, an annotator may perform instance segmentation of all body parts both natural and unnatural (e.g., clothes) and assigns a color component/attribute classification to facial regions, at 504, resulting in instance segmentation mask 506. Using the instance segmentation mask 506, semantic segmentation for body parts may be performed, at 508, resulting in an intermediate semantic segmentation mask for body parts 510. Additionally, using the instance segmentation mask 506, person instance segmentation may be performed, at 512, resulting in a panoptic segmentation mask for a whole body 514. At 516, the intermediate semantic segmentation mask 510 may be used to remove unnatural parts from the panoptic segmentation mask 514, resulting in mask 518. Color component/attribute classifications from the instance segmentation mask 506 may be propagated to the mask 518, at 520, resulting in a color component/attribute segmentation mask 522.

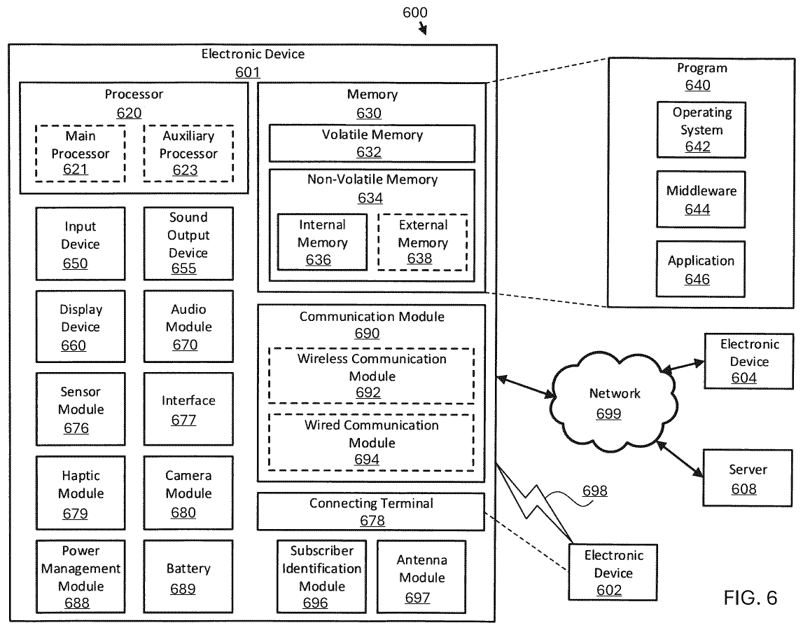

FIG. 6 is a block diagram of an electronic device in a network environment 600, according to an embodiment.

Referring to FIG. 6, an electronic device (or UE) 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a CPU or an application processor (AP)), and an auxiliary processor 623 (e.g., a GPU, an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
identifying, by a processor of an electronic device, a person instance in an image;
generating, by the processor, an attribute classification and a color component classification for a facial region of the person instance;
combining, by the processor, the attribute classification and the color component classification into a single classification for the facial region; and
propagating, by the processor, the single classification to remaining natural portions of the person instance in the image.

2. The method of claim 1, wherein performing attribute classification and color component classification of the facial region comprises:
detecting, by a face detection model, the facial region of the person instance in the image;
determining, by a first neural network, the attribute classification based on the facial region; and
determining, by at least one of a second neural network or a clustering-based algorithm, the color component classification based on the facial region.

3. The method of claim 2, wherein determining the color component classification comprises:
pre-processing the facial region for the second neural network to generate a pre-processed facial region;
performing color component classification, by the second neural network, to generate a first color component classification for the facial region and a first confidence measure for the first color component classification.

4. The method of claim 3, wherein determining the color component classification comprises:
identifying pixels in the facial region corresponding to skin areas of the facial region;
converting the pixels into a color space;
clustering the converted pixels into dominant colors; and
determining a second color component classification for the facial region based on the dominant colors, and a second confidence measure for the second color component classification; and
determining the color component classification for the facial region from among the first color component classification and the second color component classification based on the first confidence measure and the second confidence measure.

5. The method of claim 4, wherein the color space comprises a hue, saturation, value (HSV) color space or a lightness, a, b (LAB) color space.

6. The method of claim 4, wherein determining the color component classification comprises
selecting one of the first color component classification and the second color component classification having a higher confidence measure among the first confidence measure and the second confidence measure.

7. The method of claim 2, wherein determining the attribute classification comprises:
selecting the attribute classification from among predefined attribute classifications using a neural network-based attribute classification model.

8. The method of claim 1, wherein propagating the single classification to remaining natural portions of the person instance comprises:
performing sematic segmentation for body parts on the image to generate a semantic segmentation mask;
performing person instance segmentation on the image to generate a person instance mask;
removing unnatural parts from the person instance mask based on the semantic segmentation mask to generate a combined mask; and
propagating the single classification for the facial region to remaining natural parts of the person instance in the combined mask to generate a color component/attribute segmentation mask.

9. The method of claim 1, wherein propagating the single classification to remaining natural portions of the person instance comprises:
receiving first input for body part instance segmentation in the image to generate a first mask;
receiving second input assigning the single classification for the facial region in the first mask;
performing person instance segmentation on the first mask to generate a second mask;
performing semantic segmentation for body parts on the first mask to generate a third mask;
removing unnatural parts from the person instance in the third mask using the second mask, to generate a fourth mask; and
propagating the single classification for the facial region to remaining natural parts of the person instance in the fourth mask, to generate a color component/attribute segmentation mask.

10. A method comprising:
detecting, by a processor of an electronic device, a facial region of a person instance in an image using a face detection model;
determining, by the processor, via a first neural network, an attribute classification based on the facial region;
determining, by the processor, via a second neural network, a first color component classification for the facial region;
determining, by the processor, via a clustering-based algorithm, a second color component classification for the facial region based on dominant colors of clustered pixels;
determining, by the processor, a color component classification for the facial region from among the first color component classification and the second color component classification; and
combining, by the processor, the attribute classification and the color component classification into a single classification for the facial region.

11. The method of claim 10, wherein:
determining the first color component classification comprises determining a first confidence measure for the first color component classification;
determining the second color component classification comprises determining a second confidence measure for the second color component classification; and
determining the color component classification comprises selecting one of the first color component classification or the second color component classification having a higher confidence measure among the first confidence measure and the second confidence measure.

12. The method of claim 10, wherein determining the second color component classification comprises:
identifying pixels in the facial region corresponding to skin areas of the facial region;
converting the pixels into a color space;
clustering the converted pixels into dominant colors; and
determining the second color component classification for the facial region based on the dominant colors.

13. The method of claim 12, wherein the color space comprises a hue, saturation, value (HSV) color space or a lightness, a, b (LAB) color space.

14. The method of claim 10, wherein determining the attribute classification comprises:
selecting the attribute classification from among predefined attribute classifications using a neural network-based attribute classification model.

15. The method of claim 10, further comprising propagating the single classification to remaining natural portions of the person instance.

16. The method of claim 15, wherein propagating the single classification to remaining natural portions of the person instance comprises:
performing sematic segmentation for body parts on the image to generate a semantic segmentation mask;
performing person instance segmentation on the image to generate a person instance mask;
removing unnatural parts from the person instance mask based on the semantic segmentation mask to generate a combined mask; and
propagating the single classification for the facial region to remaining natural parts of the person instance in the combined mask to generate a color component/attribute segmentation mask.

17. The method of claim 15, wherein propagating the single classification to remaining natural portions of the person instance comprises:
receiving first input for body part instance segmentation in the image to generate a first mask;
receiving second input assigning the single classification for the facial region in the first mask;
performing person instance segmentation on the first mask to generate a second mask;
performing semantic segmentation for body parts on the first mask to generate a third mask;
removing unnatural parts from the person instance in the third mask using the second mask, to generate a fourth mask; and
propagating the single classification for the facial region to remaining natural parts of the person instance in the fourth mask, to generate a color component/attribute segmentation mask.

18. An electronic device comprising:
a processor; and
a non-transitory computer readable storage medium storing instructions that, when executed, cause the processor to:
identify a person instance in an image;
generate an attribute classification and a color component classification for a facial region of the person instance;
combine the attribute classification and the color component classification into a single classification for the facial region; and
propagate the single classification to remaining natural portions of the person instance in the image.

19. The electronic device of claim 18, wherein, in performing attribute classification and color component classification of the facial region, the instructions further cause the processor to:
detect, by a face detection model, the facial region of the person instance in the image;
determine, by a first neural network, the attribute classification based on the facial region; and
determine, by a second neural network, a first color component classification for the facial region;
determine, by a clustering-based algorithm, a second color component classification for the facial region based on dominant colors of clustered pixels; and
determine the color component classification for the facial region from among the first color component classification and the second color component classification.

20. The electronic device of claim 19, wherein:
in determining the first color component classification, the instructions further cause the processor to determine a first confidence measure for the first color component classification;
in determining the second color component classification, the instructions further cause the processor to determine a second confidence measure for the second color component classification; and
in determining the color component classification, the instructions further cause the processor to select one of the first color component classification or the second color component classification having a higher confidence measure among the first confidence measure and the second confidence measure.
